(19) United States
(12) Patent Application Publication
(10) Pub. No.: US 2026/0332575 A1
(43) Pub. Date: Oct. 22, 2026

(54) Unlocking a Data Storage Device with Alternate Password

(71) Applicant: Sandisk Technologies, Inc., Milpitas, CA (US)

(72) Inventors: Ganesh Kumar Pathirakani, Kovilpatti (IN); Nagarajan Ragupathy, Kovilpatti (IN); Eshwaran M, Bangalore (IN)

(73) Assignee: Sandisk Technologies, Inc., Milpitas, CA (US)

(21) Appl. No.: 19/185,247

(22) Filed: Apr. 22, 2025

(51) Int. Cl. H04L 9/40

(52) U.S. Cl. CPC H04L 63/083

(57) ABSTRACT

A method to unlock a data storage device. In a first mode, the method includes receiving a first password from a host device and based on the first password corresponding to a first authentication dataset, unlocking the data storage device to enable access to the storage medium. In a second mode, the method includes receiving an alternate password and based on the alternate password corresponding to an alternate authentication dataset, unlocking the data storage device to enable access to the storage medium or to enable reset of the first authentication dataset. Operation in the second mode is responsive to a user selection or receiving a first password that does not correspond to the first authentication dataset.

### TECHNICAL FIELD

A secure data storage device and method of unlocking to access a secured portion of the data storage device.

### BACKGROUND

It is important to protect confidential data stored in a data storage device. Without protection, a malicious user can steal confidential data from the data storage device by copying the confidential data to another storage medium.

To prevent, or reduce, the likelihood of unauthorized access to confidential data, a data storage device can have mechanisms to lock access to the user data. To unlock, presentation of a valid password to the password mechanism enables access to the data.

If a valid authenticated user forgets their password, this can prevent the authenticated user from accessing the data, with the consequence of losing valuable data. In other examples, a password mechanism may be subject to brute force algorithms or repetitive attacks in an attempt to unlock the data storage device.

### SUMMARY

A method to unlock a data storage device, wherein in a first mode, the method comprises: receiving, from a host device, a first password; comparing the first password with a first authentication dataset; and based on the first password corresponding to the first authentication dataset, unlocking the data storage device to enable the host device to access at least a secured portion of a storage medium of the data storage device. Responsive to a user selection to operate in a second mode, or responsive to receiving the first password that does not correspond to the first authentication dataset, the method includes operating in the second mode comprising: receiving, from the host device, at least one alternate password; comparing the at least one alternate password with at least one alternate authentication dataset; and based on the at least one alternate password corresponding to the at least one alternate authentication dataset, unlocking the data storage device. Unlocking the data storage device includes: enabling reset of the first authentication dataset; or enabling the host device to access the secured portion.

In some examples of the method, the at least one alternate authentication dataset includes a plurality of alternate authentication datasets corresponding to a plurality of alternate passwords, wherein each authentication dataset is associated with a corresponding alternate password. The second mode further comprises: receiving, from the host device, an alternate password indicator that is indicative of a specific alternate authentication dataset in the plurality of alternate authentication datasets. Comparing the at least one alternate password comprises comparing with the specific alternate authentication dataset.

In some examples of the method, in response to the first password that does not correspond with the first authentication dataset, the method further comprises: incrementing a failed attempt counter. In response to the failed attempt counter satisfying, or exceeding, a first specified threshold, unlocking the data storage device in the first mode is disabled.

In some examples of the method, wherein in response to: the failed attempt counter satisfying, or exceeding, the first specified threshold; and receiving, from the host device, a subsequent first password that corresponds with the first authentication dataset, and in response the method further comprises operating in the second mode. In response to unlocking the data storage device in the second mode, the method further comprises resetting the failed attempt counter.

In some alternative examples of the method, in response to the failed attempt counter satisfying, or exceeding, a first specified threshold, the method includes operating in a third mode. The third mode comprising: receiving, from the host device, a subsequent first password and at least one alternate password; comparing the first password with the first authentication dataset; comparing the at least one alternate password with at least one alternate authentication dataset; and based on both the first password corresponding to the first authentication dataset and the at least one alternate password corresponding to the at least one alternate authentication dataset, unlocking the data storage device to enable the host device to access the secured portion of the storage medium.

In some examples of the method, a second specified threshold is higher than the first specified threshold, wherein first specified threshold and second specified threshold are associated with respective first and second alternate authentication datasets. In response to the failed attempt counter satisfying, or exceeding, both the first specified threshold and the second specified threshold, the third mode further comprises: sending a request for at least a first alternate password and a second alternate password. The step of receiving the first password and at least one alternate password comprises receiving the first alternate password and the second alternate password. Comparing the at least one alternate password with at least one alternate authentication dataset comprises: comparing the first alternate password with the first alternate authentication dataset; and comparing the second alternate password with the second alternate authentication dataset. Unlocking the data storage device is based on both the first and second alternate passwords corresponding to the first and second alternate authentication datasets.

In some examples of the method, wherein in the second mode, receiving the at least one password comprises: receiving, from the host device, a secure digital (SD) security protocol command, determining, from a parameter list of the SD security protocol command, the at least one alternate password; and determining, from the bit 5, 6, and 7 of byte 0 of the parameter list, a identifier of the at least one alternate password. Based on the identifier of the at least one password, the method includes identifying the at least one alternate authentication dataset for the step of comparing the at least one alternate passwords with the at least one authentication dataset.

In some examples of the method, a first password length of the first password is different to an alternate password length of one of the at least one alternate password.

In some examples of the method, the data storage device is a secure digital (SD) card.

A data storage device comprising: a storage medium configured to store user data; and at least one processor. In a first mode the at least one processor is configured, individually or in combination, to: receive, from a host device, a first password; compare the first password with a first authentication dataset; and based on the first password corresponding to the first authentication dataset, unlock the data storage device to enable the host device to access at least a secured portion of a storage medium of the data storage device. Wherein responsive to a user selection to operate in a second mode, or responsive to a first password that does not correspond to the first authentication dataset, the at least one processor is configured, individually or in combination, to operate in a second mode to: receive, from the host device, at least one alternate password; compare the at least one alternate password with at least one alternate authentication dataset; and based on the at least one alternate password corresponding to the at least one alternate authentication dataset, unlock the data storage device. To unlock the data storage device comprises: enabling reset of the first authentication dataset; or enabling the host device to access the secured portion.

In some examples of the data storage device, the at least one alternate authentication dataset includes a plurality of alternate authentication datasets corresponding to a plurality of alternate passwords, wherein each authentication dataset is associated with a corresponding alternate password. In the second mode, the at least one processor is further configured, individually or in combination, to: receive, from the host device, an alternate password indicator that is indicative of a specific alternate authentication dataset in the plurality of alternate authentication datasets; and wherein to compare the at least one alternate password comprises comparing with the specific alternate authentication dataset.

In some examples of the data storage device, in response to the first password that does not correspond with the first authentication data set, the at least one processor is further configured, individually or in combination, to: increment a failed attempt counter. In response to the failed attempt counter satisfying, or exceeding, a first specified threshold, unlocking the data storage device in the first mode is disabled.

In some examples of the data storage device, in response to: the failed attempt counter satisfying, or exceeding, the first specified threshold; and receiving, from the host device, a subsequent first password that corresponds with the first authentication dataset, the at least one processor is further configured, individually or in combination, to operate in the second mode. In response to the data storage device being unlocked in the second mode, the at least one processor is further configured, individually or in combination, to reset the failed attempt counter.

In some examples of the data storage device, in response to the failed attempt counter satisfying, or exceeding, a first specified threshold, the at least one processor is further configured, individually or in combination, to operate in a third mode to: receive, from the host device, a subsequent first password and at least one alternate password; compare the first password with the first authentication dataset; compare the at least one alternate password with at least one alternate authentication dataset; and based on both the first password corresponding to the first authentication dataset and the at least one alternate password corresponding to the at least one alternate authentication dataset, unlock the data storage device to enable the host device to access the secured portion of the storage medium.

In some examples of the data storage device, a second specified threshold is higher than the first specified threshold, wherein first specified threshold and second specified threshold are associated with respective first and second alternate authentication datasets. In response to the failed attempt counter satisfying, or exceeding, both the first specified threshold and the second specified threshold, the at least one processor in the third mode is further configured, individually or in combination, to: send a request for at least a first alternate password and a second alternate password. Wherein to receive the first password and at least one alternate password comprises to receive the first alternate password and the second alternate password. To compare the at least one alternate password with at least one alternate authentication dataset comprises: to compare the first alternate password with the first alternate authentication dataset; and to compare the second alternate password with the second alternate authentication dataset. Wherein to unlock the data storage device is based on both the first and second alternate passwords corresponding to the first and second alternate authentication datasets.

In some examples of the data storage device, to receive the at least one password in the second mode comprises the at least one processor configured, individually or in combination, to: receive, from the host device, a secure digital (SD) security protocol command; determine, from a parameter list of the SD security protocol command, the at least one alternate password; determine, from the bit 5, 6, and 7 of byte 0 of the parameter list, a identifier of the at least one alternate password; and based on the identifier of the at least one password, identify the at least one alternate authentication dataset to compare the at least one alternate passwords with the at least one authentication dataset.

In some examples of the data storage device, a first password length of the first password is different to an alternate password length of one of the at least one alternate password.

In some examples the data storage device is a secure digital (SD) card.

A data storage device comprising: means for storing user data; and means to operate in a first mode. The means to operate in the first mode comprising: means for receiving, from a host device, a first password; means for receiving the first password with a first authentication dataset; and based on the first password corresponding to the first authentication dataset, means for unlocking the data storage device to enable the host device to access at least a secured portion of the means for storing user data. The data storage device also includes means to operate in a second mode that is responsive to a user selection to operate in a second mode, or responsive to a first password that does not correspond to the first authentication dataset. The means to operate in the second mode comprising: means for receiving, from the host device, at least one alternate password; means for comparing the at least one alternate password with at least one alternate authentication dataset; and based on the at least one alternate password corresponding to the at least one alternate authentication dataset, means for unlocking the data storage device. Unlocking the data storage device includes to: enable reset of the first authentication dataset; or to enable the host device to access the secured portion.

In some examples of the data storage device, the at least one alternate authentication dataset includes a plurality of authentication datasets corresponding to a plurality of passwords, wherein each authentication dataset is associated with a corresponding alternate password. The means to operate in the second mode further comprising: means to receive, from the host device, an alternate password indicator that is indicative of a specific alternate authentication dataset in the plurality of alternate authentication datasets; and wherein the means for comparing the at least one alternate passwords comprises means for comparing the at least one alternate password with the specific authentication dataset.

### BRIEF DESCRIPTION OF DRAWINGS

FIG. 1 illustrates a schematic of a data storage device in communication with a host device;

FIG. 2 illustrates a flow diagram of a method to unlock a data storage device that includes a mode to unlock the device with an alternate password;

FIG. 3 illustrates a flow diagram of a method to enrol passwords to unlock the data storage device;

FIG. 4 illustrates a flow diagram of a method to unlock the data storage device with an alternate password as a recovery password;

FIG. 5 illustrates a user interface generated at a display of the host device to provide options for a user to setup the data storage device and associated passwords;

FIG. 6 illustrates a user interface generated at a display of the host device to prompt a user to enter a first password for enrolment;

FIG. 7 illustrates a user interface generated at a display of the host device to notify a user of successful setup of the first password;

FIG. 8 illustrates a user interface generated at a display of the host device to prompt a user to enter a number of alternate passwords to be setup;

FIG. 9 illustrates a user interface generated at a display of the host device to prompt a user to enter a first alternate password for enrolment;

FIG. 10 illustrates a user interface generated at a display of the host device to prompt a user to enter a second alternate password for enrolment;

FIG. 11 illustrates a user interface generated at a display of the host device to prompt a user to set trigger conditions to operate in a mode for using alternate passwords to unlock the data storage device;

FIG. 12 illustrates a user interface generated at a display of the host device to notify a user of successful setup of the first password and alternate passwords;

FIG. 13 illustrates a user interface generated at a display of the host device to prompt the user to enter the first password to unlock the data storage device or alternatively select an option to use an alternative password;

FIG. 14 illustrates a user interface generated at a display of the host device to provide the user the option of a specific alternate password from a plurality of alternate passwords for unlocking the data storage device;

FIG. 15 illustrates a user interface generated at a display of the host device to prompt the user to enter a first alternate password to unlock the data storage device;

FIG. 16 illustrates a user interface, for an alternative, where the host device prompts the user to enter multiple alternate passwords to unlock the data storage device;

FIG. 17 illustrates a portion of the parameter list of a security protocol command, including use of a reserved field for an identifier to identify an alternate password, or to indicate a level of the alternate passwords;

FIG. 18 is a truth table for the reserve field of FIG. 17;

FIG. 19 illustrates a flow diagram of a method to unlock a data storage device that includes a mode to unlock the device with multi-tier passwords, including an alternate password;

FIG. 20 illustrates a flow diagram of a method to enrol passwords to unlock the data storage device in accordance with the method illustrated in FIG. 19;

FIG. 21 illustrates a flow diagram of a method to unlock the data storage device that includes unlocking the data storage device on the condition valid passwords have been presented to the required authentication levels;

FIG. 22 illustrates a user interface generated at a display of the host device to provide options for a user to set a desired device authentication level;

FIG. 23 illustrates a user interface generated at a display of the host device to prompt a user to enter a first password for enrolment;

FIG. 24 illustrates a user interface generated at a display of the host device to prompt a user to enter a first alternate password for enrolment, where the first alternate password can be used for a second level of authentication and higher;

FIG. 25 illustrates a user interface generated at a display of the host device to prompt a user to enter a second alternate password for enrolment, where the second alternate password can be used for a third level of authentication and higher;

FIG. 26 illustrates a user interface generated at a display of the host device to prompt the user to enter the first password to unlock the data storage device;

FIG. 27 illustrates a user interface generated at a display of the host device to prompt the user to enter a first alternate password for second level authentication to unlock the data storage device;

FIG. 28 illustrates a user interface generated at a display of the host device to unlock the data storage device in an alternative mode. This includes a prompt for the user to enter a first password and the first alternate password for second level authentication to unlock the data storage device;

FIG. 29 illustrates a user interface generated at a display of the host device to unlock the data storage device in an alternative mode. This includes a prompt for the user to enter a first password, the first alternate password, and the second alternate password for third level authentication to unlock the data storage device;

FIG. 30 illustrates a portion of the parameter list of a security protocol command, including use of a reserved field to identify a level of authentication, or respective alternate password, for the methods described with reference to FIGS. 19 to 29; and

FIG. 31 is a truth table for the reserve field of FIG. 31.

### DESCRIPTION OF EMBODIMENTS

### Overview

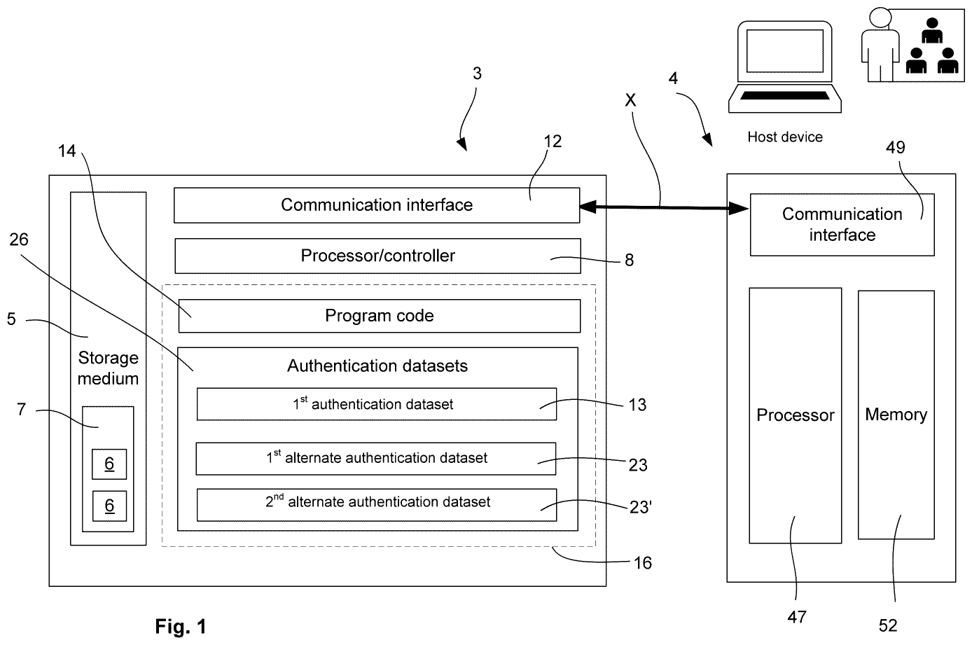

FIG. 1 illustrates a data storage device 3 configured to be in communication with a host device 4. The data storage device 3 includes a storage medium 5 configured to have a secured portion 7 to store user data 6.

The data storage device 3 also includes a communication interface 12 configured to communicate with the host device 4. The data storage device 3 also comprises at least one processor 8 (e.g. SD controller chip) configured to execute program code 14 stored in a configuration memory 16 to issue commands for controlling operation of the data storage device 3. In the illustrated example, authentication datasets 26, 13, 23 are stored in the memory 16 (although in other examples the authentication datasets 13, 23 may be stored in the storage medium 5).

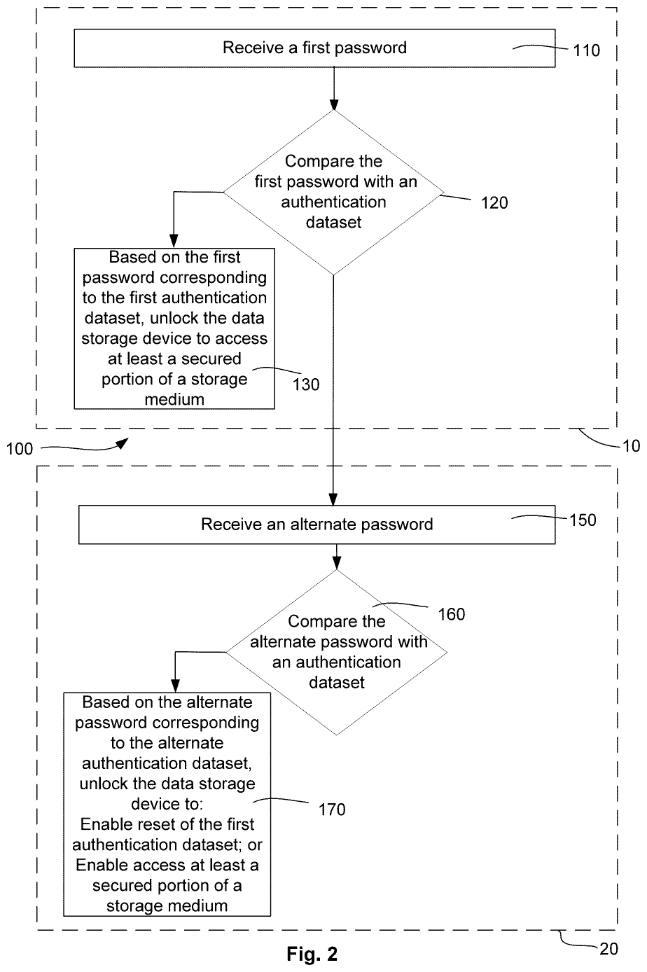

The at least one processor 8 is configured, individually or in combination, to perform steps in a method 100, as illustrated in FIG. 2 to selectively unlock 130, 170 the data storage device 3. This includes at least two modes. A first mode 10 includes steps to unlock the data storage device 3, that may be typically associated during routine unlocking with a first password 11. The second mode 20 includes steps to unlock the data storage device 3 that includes use of alternate password(s) (21, 21′). In some examples, initiation of the second mode 20 may be as a result of a user selection 19 to operate in the second mode (for example a user forgetting the password and using the second mode 20 as an alternative unlocking means). In other examples, the second mode 20 may be initiated in response to an incorrect first password 11 being received when operating in the first mode 10 (for example, to require further or additional alternate passwords 21, 21′ to resist brute force attacks after receiving incorrect first passwords 11). In some examples, the second mode 20 may be initiated after receiving a threshold number of invalid passwords.

In the first mode 10, the method includes receiving 110, from the host device 4, a first password 11. The first password 11 may be entered by the user via a user interface at the host device 4 and, in turn, sent to the data storage device 3. The method 100 further includes comparing 120 the first password 11 with a first authentication dataset 13. The first authentication dataset 13 can include the first password 11, or other data to enable authentication of the first password 11 (such as a key from a cryptographic pair). Based on the first password 11 corresponding to the first authentication data set 13 (that is, the first password 11 is correct), the method 100 further includes unlocking 130 the data storage device to enable the host device 4 to access at least a secured portion of the storage medium 5. This can include the processor 8 enabling reading, write, and erase function between the storage medium 5 and the host device 4. In normal use, the first mode 10 is the desired mode of operation as this enables a user to easily unlock, and use, the data storage device 3.

In the second mode 10, the method 100 requires an additional level of password authentication. Reasons can include a user forgetting the first password 11 or entering the wrong first password. The method 100 in the second mode 20 includes receives 150, from the host device 4, at least one alternate password 21. Like the first password, the alternate password 21 can be entered via a user interface at the host device 4. In some examples, entering the alternate password 21 may be in response to a request from the data storage device 3 for an alternate password. In other examples, entering the alternate password 21 may be in response to initiative from the host device 4 and user side.

The method 100 further includes comparing 160 the at least one alternate password 21 with a least one alternate authentication dataset 23. The first authentication dataset 13 is different to the alternate authentication dataset 23 (corresponding to a valid first password 11 being different to the alternate password 21). Based on the at least one alternate password 21 corresponding to the at least one alternate authentication dataset 23, the method include unlocking 170 the data storage device 3. In the second mode 20, unlocking 170 may include enabling reset 172 of the first authentication dataset 13. That can include enrolment of a new first authentication dataset 13 and first password 11 combination. In other examples, this unlocking 170 can include enabling the host device 4 to access 174 the secured portion 7.

Examples of the data storage device 3 can advantageously enable an alternative mechanism to unlock the data storage device if first password 11 is forgotten. In other examples, the data storage device 3 can advantageously provide additional layers of security (of requiring further alternate passwords) if incorrect passwords are received.

A detailed example of non-limiting embodiments will now be described.

### Data Storage Device

The data storage device 3, in general, is configured to be used with a host device 4 to store user data. In some examples, the data storage device 3 is a mass storage device that is a peripheral device to a core host device 4. In some examples, the data storage device 3 is a memory card, such as a secure digital (SD) card. It is to be appreciated that the data storage device 3 may, in alternative examples, be other types of storage devices such as solid state drives (SSD), hard disk drives (HDD), hybrid drives, etc.

The data storage device 3 is configured with security features to control access to user data 6 stored in the data storage device 3. This includes use of passwords to control access to specified secured portions 7 of the data storage device 3. In some examples, the specified secured portions 7 can be specific physical portions of the storage medium. In other examples, the specified secured portions 7 can include logical block ranges.

In some examples, the data storage device 3 includes additional security features, such as a cryptography engine, to encrypt data stored in the storage medium. In some examples, the data storage device 3 is a self-encrypting drive (SED).

In some examples, the data storage device 3 may be mounted within a housing of the host device 4 (such as a computer). In examples where the data storage device 3 is an SD card, this can include inserting the data storage device 3 into an SD card slot of a computer. In other examples, a memory card reader, as an intermediate peripheral device between the data storage device 3 and the host device 4.

### Communication Interface 12

The communication interface 12 enables the data storage device 3 to communicate with the communication interface 49 of the host device 4.

In some examples, the data storage device 3 and the host device 4 communicate in accordance with secure digital (SD) memory card specifications and SD standards. This can include standards and specifications developed by the SD Association.

In some examples, communication between the data storage device 3 and the host device 4 can include a security protocol command to lock and/or unlock at least part of the data storage device 3. Specifically, this can include an SD security protocol command. More specifically, the SD security protocol command is CMD42.

### Storage Medium 5

The storage medium 5 is configured to store user data. This can include a non-volatile storage medium that is non-transitory to retain the stored block data irrespective of access to a power source from a host device 4.

The storage medium 5 may be a hard disk drive (HDD) with a rotating magnetic disk or a solid state drive (SSD) and its variations like SLC (Single Level Cell), eMLC (Enterprise Multi Level Cell), MLC (Multi Level Cell), TLC (Triple Level Cell), and QLC (Quadruple Level Cell), and combinations of the above such as SSHD (solid state hybrid drive). Any other type of non-volatile storage media may also be used, including emerging non-volatile memory such as Program in Place or Storage Class Memory (SCM), such as ReRam, PCM, and MRAM. Further, the storage medium 5 may be a block data storage device, such that the user data is written in blocks to the storage medium 5 and read in blocks from the storage medium 5.

In some examples, the storage medium 5 includes flash memory (such as NAND flash). This can include SD cards with onboard flash memory as the storage medium 5. Flash memory may include a plurality of blocks, where each block is the smallest unit that can be erased. Each block contains a plurality of flash memory units (FMU), where the FMU is the smallest data chunk that the can be used to read or write to the flash memory. Because each block is the smallest unit that can be erased, to erase or modify data in one FMU involves erasing at least an entire block and rewriting the block (or to a new physical block).

The plurality of blocks have physical addresses associated with the blocks. As discussed herein, logical block addresses (which are used at the host device side) will need to be mapped to these physical addresses. This can be facilitated with the logical to physical (L2P) mapping table.

Since data corresponding to different users are stored in the storage medium, the data corresponding to different users may be logically separated. Thus in one example, locking and unlocking the data storage device 3 may include locking and unlocking respective secured portions based on logical block ranges. This can include the storage medium 5 to be configured to store user data of an enrolled user in a first logical block addressing (LBA) range as well as other user data of other enrolled users in another corresponding LBA range in the plurality of logical block ranges (i.e. multiple logical block ranges).

### Processor 8

The at least one processor 8 is associated with memory 16 storing computer-readable instructions (such as software and/or firmware) to implement the methods described herein. A processor may comprise one or more of microprocessors, microcontrollers, controlling circuitry, or a combination thereof. The one or more processors are, in combination or individually, configured to execute program code stored within the memory 16 to issue commands for controlling the operation of the data storage device 1.

The at least one processor 8 is configured to perform functions associated with access control, including verifying passwords of a user from the host device and, in response to verification, selectively enabling functions with corresponding secured portion(s) 7 for that user.

In one example, the at least one processor 8 may include a reduced instruction set computer (RISC). In one example, the at least one processor 8 is a SD card controller.

### Configuration Memory 16

Configuration memory 16 stores data related to configuration of the data storage device 3. This may include data related to access control (including authentication datasets), other data related to enrolled users, range table, L2P mapping table, settings, and other configuration parameters and metadata used for operation of the data storage device 3. It may also include data related to usage and health of the storage medium, age of data stored in the storage medium, and other parameters.

The configuration memory 16 can also store firmware and/or software such as program code 14 for operation of the method and the at least one processor 8.

It is to be appreciated that the storage medium 5 may also be configured as a non-volatile data storage for firmware, software, mapping tables, authentication data set, and other metadata. This can include data that would be loaded to RAM (random access memory) used by the processor 8 during an operating session. This enable preservation of metadata when the data storage 3 is unpowered and not in use.

### Authentication Datasets 26

The authentication dataset 26 include records corresponding to a plurality of enrolled passwords 11, 21, 24. In some examples, the authentication dataset 26 may include the actual passwords. In other examples, the authentication dataset 26 may include data to enable verification of passwords received 110, 150 from the host device 4. This may include data that forms a cryptographic pair with the password.

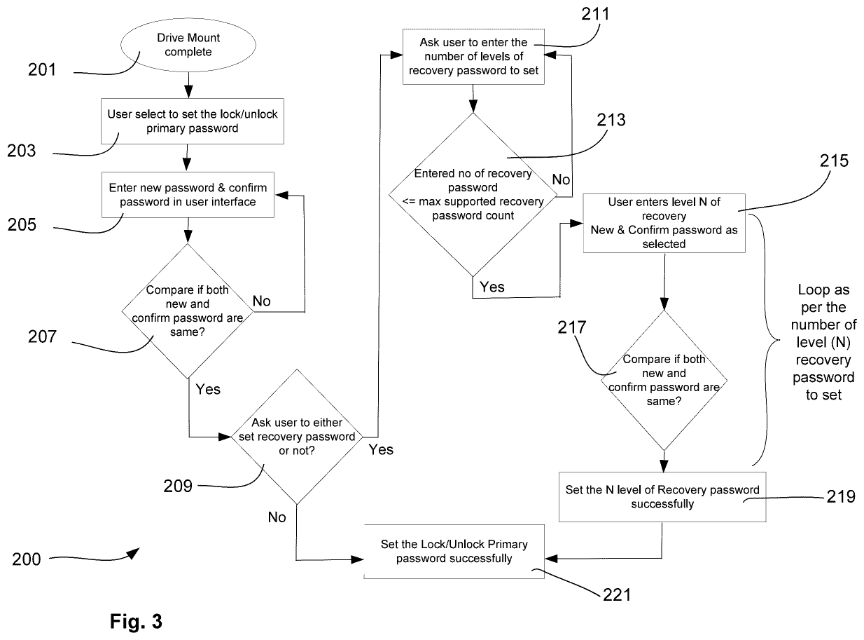

Referring to FIG. 3 the authentication dataset 26 includes a first authentication dataset 13 (corresponding to a first password 11) and at least one alternate authentication dataset 23 (corresponding to a first alternate password 21). These authentication datasets 13, 23 are used to enable comparison of various passwords at different levels (as will be discussed below). Additional alternate authentication datasets 23′ (to correspond to a second or subsequent alternate password 21′).

In some examples, the first authentication dataset 13 is associated with a respective logical block ranges of the data storage device 3 (to aid defining the respective secured portion 7). In some examples, each first authentication dataset may be associated with an identifier that, in turn, is associated with a respective logical block range.

### Range Table and Logical to Physical Mapping Table

A range table (not shown) in the memory 16 may include an association of the first authentication dataset/first password with corresponding one or more logical block ranges 21 that form the respective secured portion 7.

A logical to physical (L2P) mapping table can be used to map the logical location of user data 6 (in the secured portion 7) to the physical location of the user data in the storage medium 5.

In some examples, where the storage medium 5 includes flash memory (such as an SD card), a flash translation layer (FTL) module is configured to user the L2P mapping table to map logical block addresses to physical addresses and enable read, write, erase, of the physical blocks.

The FTL module may be implemented by the at least one processor 8 or by a separate hardware module.

Although the range table and the L2P mapping table can be separate, it is to be appreciated that in other examples these two tables could be combined as one table or dataset in the memory 16.

### Host Device 4

The host device 4 can be a computer system, computer, laptop, tablet, smartphone, etc. In some examples, the host device 4 may include a networked computer system and may include, in part, a server. In some examples, the host device 4 can include other electronic devices that is configured to host a data storage device 3. For example, a gaming console, a smart television, a security camera system, other data recording device, etc. This may be useful for cases where information needs be written and/or accessed securely based on the respective enrolled user.

The host device 4 may issue requests to access the data storage device 3 to enable user data to be read, stored, modified, and/or erased in the storage medium 5.

The host device 3 includes at least one processor 47 and at least one memory 52. The processor 47 is configured to execute instructions from firmware and software stored in the memory 52. A communication interface 49 enables communication with peripherals, which can include the data storage device 3. In some examples, the communication interface 49 may include a universal serial bus (USB).

When the host device 4 is used with the data storage device 3 for a session, the user provides credentials (such as a password) to enable access to the storage medium 5 (or secured portion 7 thereof). This can include entering such details via a user interface of the host device 4.

To enable this process, some examples include use of additional software, such as a driver, to enable these functions (as will be discussed below). In some examples, the additional software may be used during enrolment and administrative changes with the data storage device 3. This can include communication to enable functions via SD security protocol commands, such as CMD42.

### Example of Password Recovery for a Data Storage Device

An example of a method 100 of using an alternate password, as a recovery password, to unlock the data storage device will now be described with reference to FIGS. 3 to 16.

### Enrolment

FIG. 3 illustrates a flow diagram to set the passwords 11, 21, 21′. In some examples, this can include an enrolment process to enrol user(s) and their respective passwords. The method 200 to set passwords include first mounting 201 the date storage device 3 with the host device 4.

When a user initially sets the password, this typically commences with the user providing credentials via a graphical user interface 61 of the host device 4. The graphical user interface 61 may be generated, at least in part, by software executed on the host device 4 for the computer-implemented method 200 (illustrated in FIG. 3).

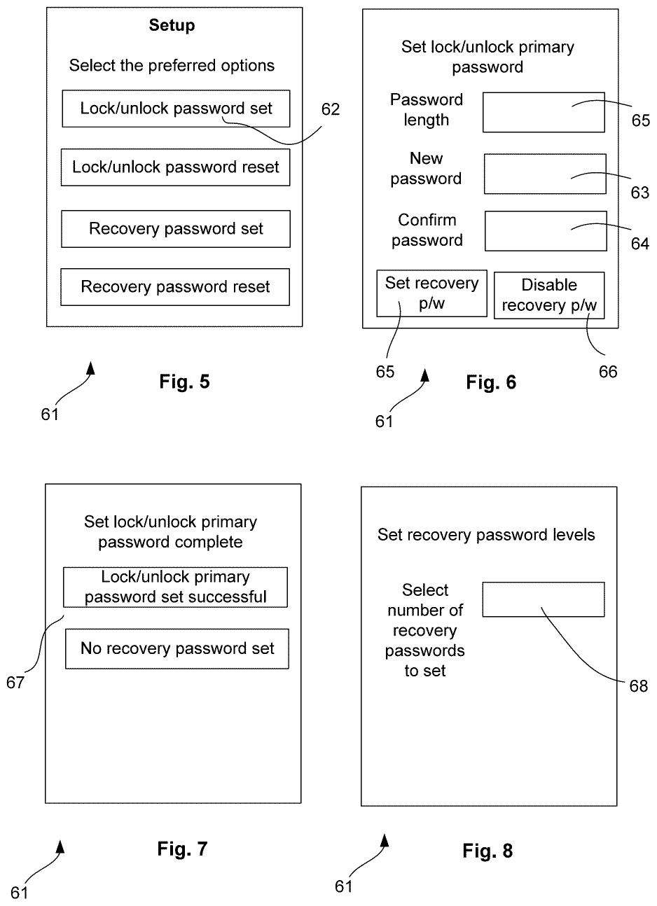

The method includes the user selecting 203 to set the first password 11. Referring to FIG. 5, this includes selecting icon 62 at a graphical user interface generated at a display of the host device. FIG. 5 also illustrates other options for the user, including resetting the first password 11 as well as setting and resetting alternate passwords 21, 21′. Referring to FIG. 6, the user can then enter details of the first password 11 (also known as a primary password) in a text box 63 and confirmatory text box 64. The confirmatory text box 64 can be used to check 207 that the first password 11 that is entered twice is the same. Optionally, the password length 43 can also be entered into box 65. Entering the password length can be used as a check on the password 11. Furthermore, in some examples the password length 43 of the first password 11 can be specified to be different to an alternate password length 45 of the alternate passwords 21. Having different passwords lengths can increase security. In other examples, the method and device can also specify a minimum password length.

After setting 205 the first password 11, the user is provided options 209 to use or disable the recovery password options. The user can select icon 65 to set the alternate password(s) 21, 21′ (which can also be known as recovery passwords). Alternatively, the user may elect only to set the first password 11 and to disable the recovery password feature by selecting icon 66.

FIG. 7 illustrates the graphical user interface 61 when the user selects icon 66, whereby the graphical user interface displays a summary 67 of the completed action, such as successfully setting 221 the first password 11 and confirming that no alternate/recovery password has been set. Successfully setting the first password 11 can include storing the first password 11 as part of the first authentication dataset 13 in the configuration memory 16. In other examples, the first password 11 may be used to derive the first authentication dataset 13 that is stored in the configuration memory 16. This can include applying a cryptographic hash function to the first password 11 and storing the result of the cryptographic hash as the first authentication dataset 13. That is, in some alternatives the first password 11 in is not stored (in plain text form) on the data storage device 3.

If the user selected icon 65 to set the alternate passwords 21, 21″, the user interface 61 as shown in FIG. 8, provides a prompt 68 to ask 211 the user to enter 215 the number of alternate passwords 21, 21′ they wish to set. In some examples, it is desirable to provide multiple alternate passwords—which can be useful if there are multiple administrators who have authority to use the recovery password to unlock the data storage device 3, where each administrator needs their own password. In other examples, multiple alternate passwords 21, 21′ may be used to provide additional levels of security—for example, requiring two or more passwords to unlock the data storage device 3.

In some examples, the method includes checking 213 that the number of recovery passwords requested by the user does not exceed the design or supported maximum number of alternate passwords.

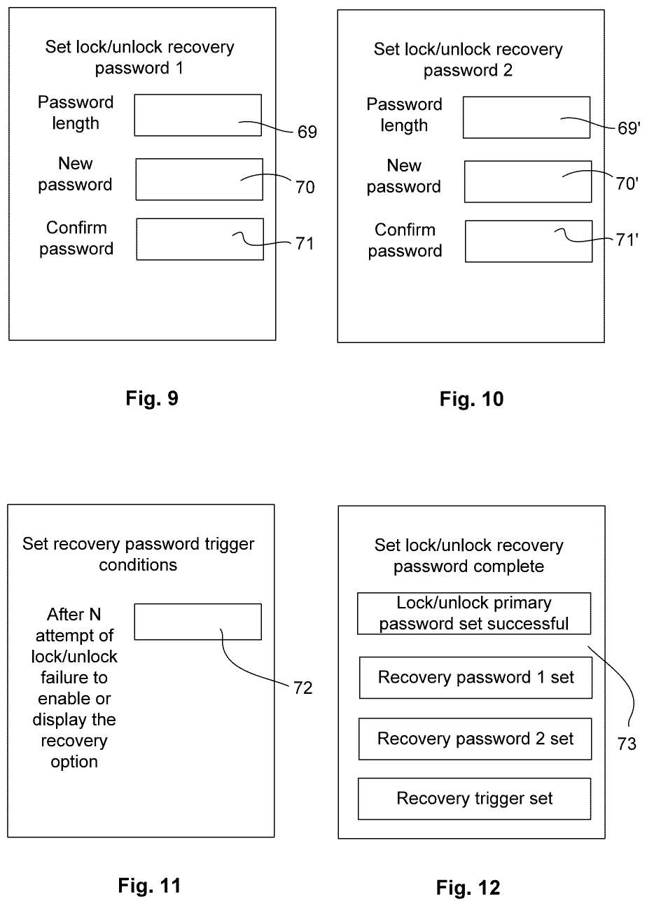

Referring to FIG. 9, entering the first alternate password includes entering the password length in a box 69, as well as entering the first alternate password 21 into a text box 70 and confirmatory text box 71. The method includes checking 217 that the entered alternate password 21 matches. If the user selects multiple recovery passwords, the method also includes providing prompts for second (or subsequent) alternate passwords 21′ as shown in FIG. 10.

Referring to FIG. 11, the method may optionally include setting trigger conditions for using the alternate passwords to unlock the data storage device 3. In one example, this includes specifying, in a text box 72, a number of unsuccessful unlock/lock attempts before the method operates in the second mode 20 or prompts the user to operate in the second mode 20.

FIG. 12 illustrates the graphical user interface 61 after successful set up to show a summary of the completed action, such as successfully setting 219 the recovery passwords 21, 21′.

### Unlocking the Data Storage Device in the First Mode 10

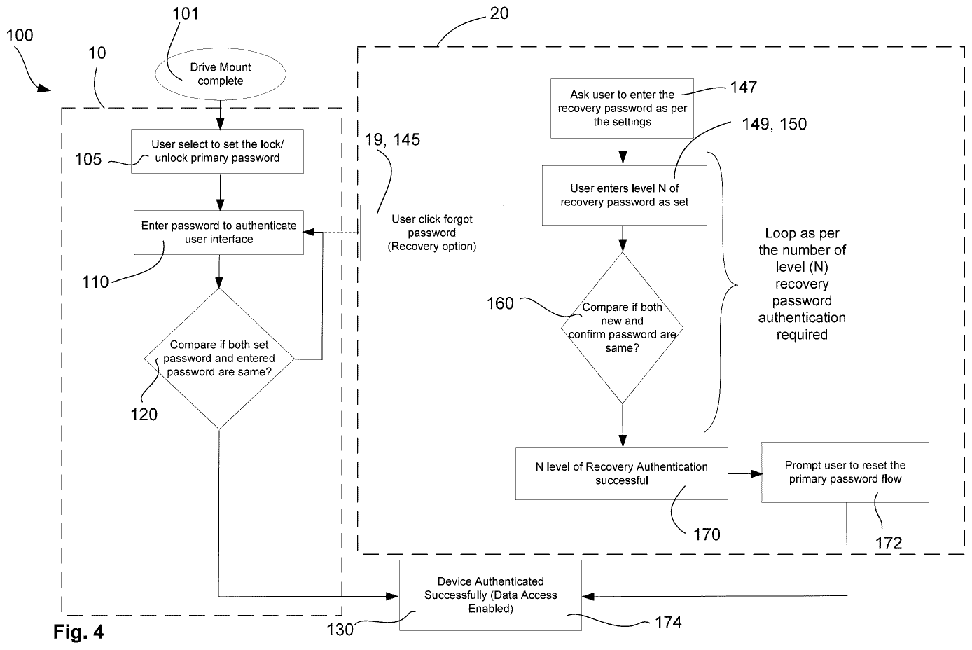

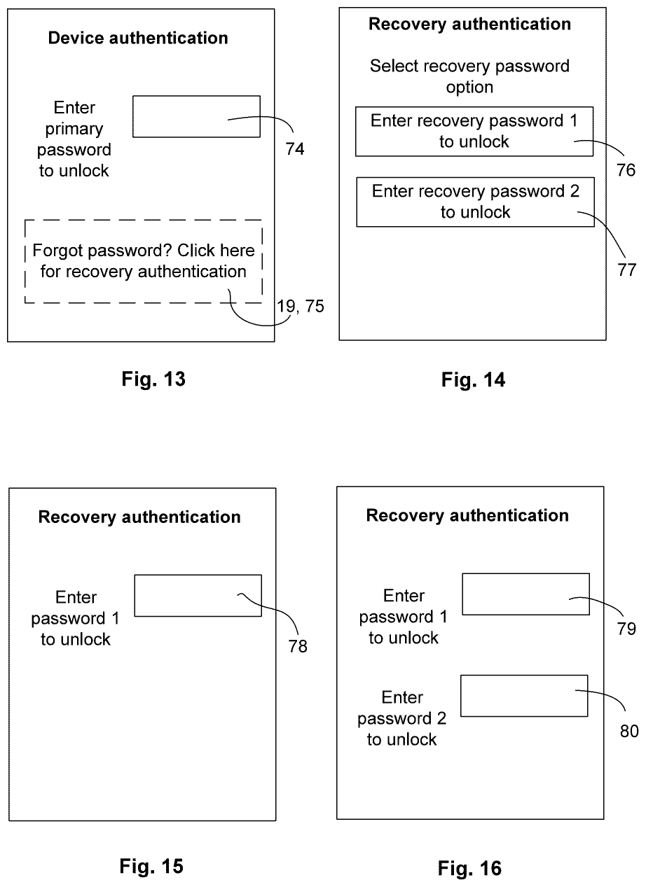

The method 100 of unlocking the data storage device 3 in the first mode 10 (will now be described with reference to FIGS. 4 and 13. Under normal use, the first mode 10 can be considered the normal or primary method of unlocking the data storage device 3.

The method 100 includes mounting 101 the data storage device 3 to the host device 4. In the example where the data storage device 3 is an SD card, this can include inserting the SD card into an SD card reader and with the host device SD driver initiating communication session with the SD card.

The method 100 can include software generating a user interface 61 at the host device 4 as shown in FIG. 13 to prompt the user to enter the first password 11. In some examples, this can include enabling the user the option to select operation in the first mode 10, thus the data storage device 3 may receive 105 a notification or message that the user has selected to operate in the first mode 10.

Referring to FIG. 13, this selection to operate in the first mode 10 can be in response to the user interface receiving a password 11 in text box 74. After the first password 11 is entered into the user interface, the host device 4 sends the first password 11 to be received 110 at the data storage device 3. The method 100 includes comparing 120 the first password 11 to the first authentication dataset 13 that was stored during the enrolment stages. In some examples, comparing 120 the first password 11 with the first authentication dataset 13 can include matching a text string of the first password 11 to the first authentication dataset 13 (i.e. to see if the text string is identical).

In other examples, comparing the first password 11 with the first authentication dataset 13 may include applying a function to the first password 11 and using the result to check if it corresponds with the first authentication dataset. For example, applying a cryptographic hash to the received first password 11 and then checking the result with the first authentication dataset 13.

Based on the first password 11 corresponding to the first authentication dataset 13 (i.e. the correct first password 11 was entered), the method includes unlocking 130 the data storage device 3 to enable the host device to access at least a secured portion 7 of a storage medium 5 of the data storage device 3. In further examples, unlocking 130 may also enable resetting of the passwords 11, 21.

In the alternative that the first password 11 does not correspond with the first authentication dataset 13, the method 100 includes directing the user to re-enter the first password 11 (to provide another attempt) and/or providing the first user the option of using an alternate password 21 in the second mode 20. Referring to FIG. 13, this includes a user selectable icon 75 for the user to explicitly select 19 the second mode 20.

In some examples, the icon 75 may be hidden during a first attempt to unlock the device in the first mode 10 and instead be presented after one or more failed attempts to unlock in the first mode 10. This can include trigger conditions as discussed above with reference to FIG. 11. In further examples, after a specified number of failed attempts, the method can be set to only enable operation in the second mode 20 to prevent brute force attacks on the first password 11 in the first mode 10.

### Unlocking the Data Storage Device in the Second Mode 20

Referring to FIG. 4, the method 100 includes receiving 145 a user selection 19 to operate in the second mode 20. In this example, where there are two alternate passwords, a graphical user interface prompts user to select which of the two alternate passwords they wish to enter (i.e. the first alternate password 21 or second alternate password 22′). This can include providing 147 icons 76, 77 for a user to select the appropriate password as illustrated in FIG. 14. FIG. 15 illustrates an example of the user interface when the user has selected the icon 76 to enter 149 the first alternate password 21. A text box 78 is provided for the user to enter the first alternate password 21. This example of allowing selection of one of the multiple alternate passwords can be useful where there are multiple users each with their own respective recovery password(s)—for example in situations where there are multiple administrators. Thus the method 100 includes receiving 151, from the host device 4, an alternate password indicator 25 that is indicative of a specific authentication dataset (e.g. first authentication dataset or second authentication dataset) in the plurality 24 of alternate authentication datasets. The specific authentication dataset 23 is then used in the comparison step 160.

FIG. 16 illustrates a graphical user interface 61 in an alternative where multiple alternate passwords 21, 21′ are required to unlock the data storage device. In this example, both the first alternate password 21 and the second alternate password 21′ are entered in respective boxes 79, 80. This system of requiring multiple alternate passwords can increase security—for example requiring two administrators (with their respective passwords) to authorise unlocking of the data storage device 3 (without the first password 11).

The alternate password(s) 21, 21′ are sent from the host device 4 to be received 150 at the data storage device 3. Referring to FIG. 4 the method 100 includes comparing 160 the alternate password(s) 21, 21′ to the alternate authentication dataset 23, 23′ that was stored during the enrolment stages. This comparison can be similar to those of comparing the first password 11 with the first authentication dataset and can include matching a text string of the alternate password to the alternate authentication dataset 13 or applying functions to the alternate passwords and matching the results of the functions with the authentication dataset 23.

Based on the alternate password 21 corresponding to the respective authentication dataset 23, the method includes unlocking 170 the data storage device 3. In some examples, this can be the first alternate password 21 corresponding the first alternate authentication data set 23. In other examples, where multiple alternate passwords are required, this can include both the first and second alternate passwords 21, 21′ corresponding to the respective first and second alternate authentication datasets 23, 23′.

When unlocking 170, this can include enabling the user to reset 172 the first authentication dataset 13. This can include the user enrolling a new first password 11. In other examples, (or as an alternative choice), unlocking 170 the data storage device 3 in the second mode 20 can also include enabling the host device to access 174 to access the secured portion 7 of the storage medium 5 of the data storage device 3.

### Example of Security Protocol Command in Password Recovery

In some examples, the host device 4 sends request to lock, and unlock, to the data storage device 3 in the form of a security command protocol. The security protocol command received 102 at the data storage device 3 may include specific forms. In particular examples, the data storage device 3 is an SD card and the security command protocol is based on standards and specifications of the SD Association. In specific examples, this includes a security protocol command in a form based of CMD42.

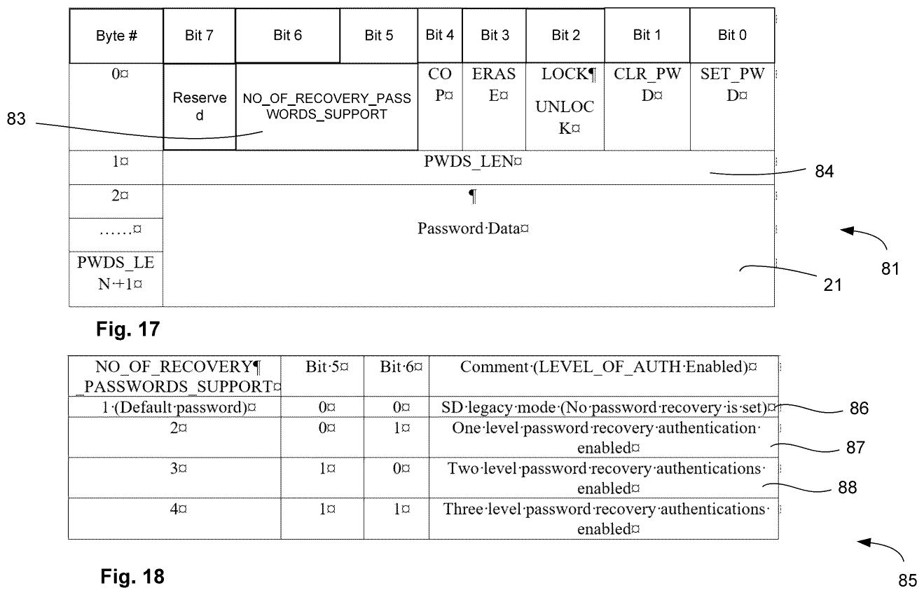

FIG. 17 illustrates a parameter list 81 of a security protocol command based on CMD42. The parameter list 81 of CMD42 includes a reserve field 83 at bits 5, 6 (and in some examples bit 7) of byte 0. The reserve field 83, in this illustrated example, is used as an identifier for the alternate password 21. A password length 84, of the alternate password 21 sent in the security protocol command, is provided at byte 1 of the parameter list 81. Finally, the password 21 is provided in byte 2 (and subsequent bytes) in the security protocol command.

Other bits in byte 0, such as bit 0 to bit 4, can be used to select specific function requests, such as setting the password, clearing the password, lock or unlock, and erase.

FIG. 18 illustrates a truth table 85 for the reserve bit 5 and bit 6 in byte 0. If both bit 5 and bit 6 are set to zero, then the security protocol command is operating in a legacy mode 86. That is, using CMD42 in accordance with known use where no password recovery is set. This legacy mode may be used, for example, when there is no password recovery and the data storage device 3 can only be unlocked with the first password 11 when operating in the first mode 10.

If bit 5 is set to zero and bit 6 is set to one, this is indicative that there is one level 87 of password recovery being enabled. That is, a first alternate password 21 and corresponding first alternate authentication dataset 23, has been enabled. In a further example, where two levels 88 of recovery authentication is enabled, bit 5 is set to one and bit 6 is set to zero. The two levels of recovery authentication includes both a first alternate password and a second alternate password 21′. It is to be appreciated additional levels, could be used. Furthermore, reserve bit 7 in byte 0 could be used which can enable specifying up to seven levels of recovery authentication (in addition to the default password authentication).

When the data storage device 3 receives the security protocol command, the processor 8 is configured to determine 104 from the parameter list 81, the alternate password (such as from bytes 2 onwards in FIG. 17). The processor 8 is also configured to determine 106, from bit 5, 6, and 7 of byte 0 of the parameter list 81, a level 41 of the at least one alternate password 21. It is to be appreciated that in some examples, the level 41 can be indicative of the quantity of the number of alternate passwords that are enabled.

In other examples, the level 41 is an identifier (or other indicator) of the specific alternate password 21 that is sent in the security protocol command. Thus the level 41 can, in some examples, be the alternate password indicator 25 indicative of a specific alternate authentication dataset 23 described above.

Based on the determined level 41, the method further includes identifying 108 the alternate authentication dataset 23 for comparing 160 with the received alternate password 21.

### Enhanced Multi-Tier Password for a Data Storage Device

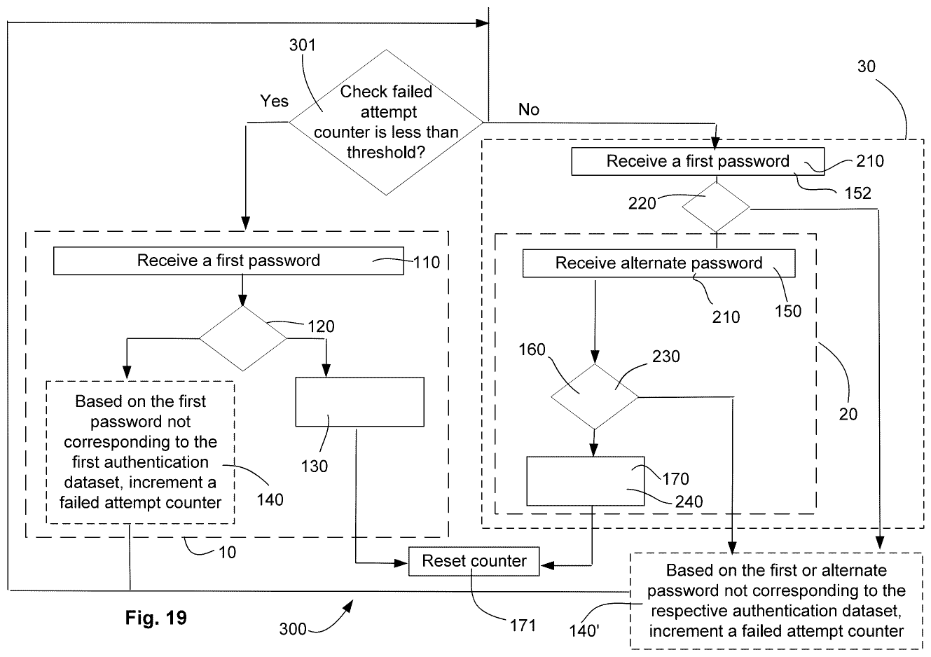

An alternative method 300 will now be described with reference to FIG. 19. In this example, the normal unlocking process is with the first mode 10 as described above using the first password 11. However, if enhanced security is required, such as failed attempts to unlock due to incorrect passwords, then the security tier can be raised by requiring one or more alternate passwords 21 to unlock the data storage device 3. In some examples the enhanced security may be triggered by, or in conjunction, with other considerations such as time of day, location, identifier of the host device (e.g. if this is the first time a specific host device is attempting to unlock the data storage device, a higher level of authentication may be required).

Referring to FIG. 19, the method includes checking 301 a value of a failed attempt counter 31 against a first specified threshold 33. The failed attempt counter 31 is incremented 140 when there is a failed attempt to unlock 130, such as when a received password 11, 21 does not correspond with the authentication dataset 13, 23. The first specified threshold can be the number of failed attempts that are allowed until enhancing security to another tier. For example, the threshold could be three, so that after three failed attempts to unlock, the user will need, in addition to a correct first password, to use an alternate password to unlock. The check 301 can include identifying if the failed attempt counter satisfies, or exceeds, the specified threshold 33.

If the failed attempt counter 31 does not satisfy the specified threshold 33, the method 300 operates in the first mode 10. However, if the failed attempt counter 31 satisfies, or exceeds, the threshold 33, the method 300 include additional steps, which can include:
a. Operating in a modified second mode (20); or
b. Operating in a third mode (30).

Turning to the modified second mode, this can include receiving 152, from the host device 4, a subsequent first password 11′ that corresponds to the first authentication dataset 13. In other words, the user is asked to re-enter the correct first password 11. The method then includes comparing 220 the subsequent first password 11 with the first authentication dataset 13. Based on the subsequent first password 11 corresponding to the first authentication dataset 13, the method continues to operate in the second mode 20 by further receiving 150 the alternate password 21 and comparing 160 the received alternate password 21 with the alternate authentication dataset 23. If the alternate password 21 and alternate authentication dataset 23 correspond, the data storage device 3 is unlocked 170. The failed attempt counter can also be reset 171. However, if the alternate password 21 does not correspond to the respective alternate authentication dataset, then the failed attempt counter is incremented (and the data storage device 3 remains locked).

Turning to an alternative third mode 30, as illustrated in FIG. 19, this includes operating in a third mode 30 that includes receiving 210 from the host device 4, both the first password 11′ and at least one alternate password 21. In some examples, both (or more) passwords are received at the same time in response to a request from the data storage device 3 for higher tier authentication. The third mode 30 further includes comparing 220 the first password 11 with the first authentication dataset 13. The third mode 30 also includes comparing the received alternate password 21 with at least one alternate authentication dataset 23. It is to be appreciated that in the third mode, the comparison steps 220, 230 can be performed in any order (i.e. comparison step 230 may precede comparison step 220). Based on both the first password 11′ corresponding to the first authentication dataset 13 and the at least one alternate password 21 corresponding to the at least one alternate authentication dataset 23, the method includes unlocking the data storage device 3 to enable the host device 4 to access the secured portion 7 of the storage medium.

The third mode 30 may achieve the same, or similar result to the modified second mode 20. In some examples, the third mode 30 may include the second mode 20 as a subset of steps. However, this is not always required and other examples have a third mode 30 that does not operate the second mode 20 and instead utilises a different order or combination of steps.

### Enrolment

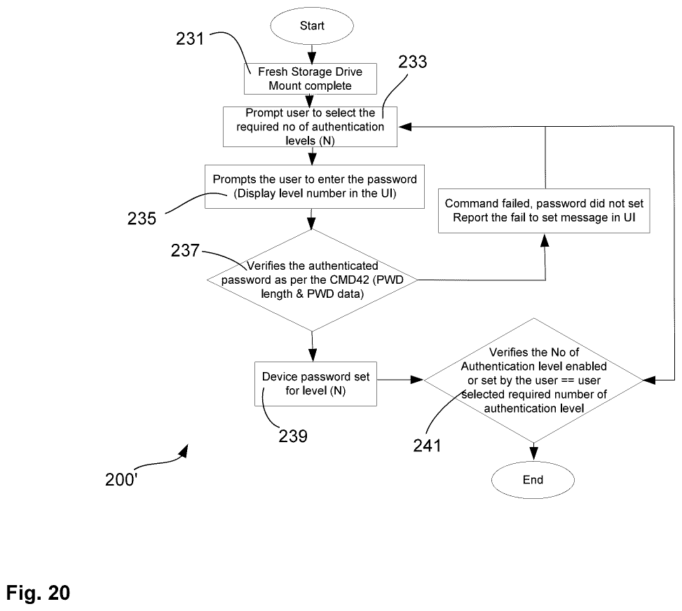

FIG. 20 illustrates a flow diagram to set the passwords 11, 21, 21′. In some examples, this can include an enrolment process to enrol user(s) and their respective passwords. The method 200′ to set passwords include first mounting 231 the date storage device 3 with the host device 4.

When a user initially sets the password, this typically commences with the user providing credentials via a graphical user interface 61 of the host device 4. The graphical user interface 61 may be generated, at least in part, by software executed on the host device 4.

The method further includes generating at the graphical user interface 61 of the host device, a prompt 89 to select 233 a required number of authentication levels. This is illustrated in FIG. 25 where the prompt 89 also includes a text box for a user to enter the number of authentication levels, for example three. The number of authentication levels is then sent to the data storage device 3.

Referring back to FIG. 20, the method also includes the user selecting 235 to set the password(s). Referring to FIG. 23, the user can then enter details of the first password 11 in a text box 63 and confirmatory text box 64. The confirmatory text box 64 can be used to check 237 that the first password 11 that is entered twice is the same. Optionally, the password length 43 can also be entered into box 65. The password length 43 can also be used as a check of the password 11.

FIG. 23 also includes a text box 90 for the user to enter a threshold number of failures to trigger the next level of authentication. This is the minimum number of failed unlocks that will trigger the method to unlock to require a password at the next level of authentication. In some examples, this can be set to zero if the user wants to have at least two levels of authentication at all times. In some examples, this can be set to one such that the second level is only triggered if there is at least one failure to correctly enter the first password 11. In further examples, the threshold can be higher, such as two, three, five, ten, etc.

The first password 11 is checked 237 to meet specified requirements, such as the two entered passwords matching, the password length matching the entered password, the password using allowable characters, password meeting minimum complexity requirements etc. In some examples, this includes verifying the password meets requirements in accordance with CMD42. If the first password 11 is allowable, the method includes setting the first password 11 and storing 239 a first authentication dataset 13 in the memory 16. Similar to the other examples described herein, the first authentication dataset 13 can be the first password 11 itself and/or other data to enable authentication of the first password 11.

The method 200′ further includes verifying 241 that the number of authentication level passwords that are set equals the required number of authentication level selected by the user in step 233. For illustrative purposes, only the first password 11 has been set (compared to the three levels of authentication selected by the user). Accordingly, the method prompts the user to set the other passwords for the other levels of authentication.

FIG. 24 illustrates a graphical user interface 61 for setting the second level of authentication (which in some examples is the first alternate password 23). This includes a text box 70 to enter the first alternate password 23 and a confirmatory text box 69 for confirming the first alternate password 23. Similar to the first password 11, a text box 69 for password length is also provided. A text box 91 is also provided to enter a threshold number of failures to trigger the text level (i.e. from the second level to the third level). In some examples, this threshold may be based on the number of incorrect attempts at the first alternate passwords 23. In yet some variations, this threshold may be based on any incorrect passwords (i.e. first password 11 or first alternate password 21) entered when the second level of authentication is required.

FIG. 25 illustrates a graphical user interface 61 for setting the third level of authentication (which in some examples is the second alternate password 23). This interface is similar to the graphical user interface 61 for setting the second level of authentication and similar features are denoted with a prime.

In some examples, the password lengths of the first password 11 is different to one or more of the alternate password lengths of the alternate passwords to increase security.

When the user sets all passwords for all the desired authentication levels, the enrolment method is complete.

### Unlocking the Data Storage Device in the First Mode 10

The method 100 of unlocking the data storage device 3 in the first mode 10 (will now be described with reference to FIGS. 4 and 13. Under normal use, the first mode 10 can be considered the normal or primary method of unlocking the data storage device 3.

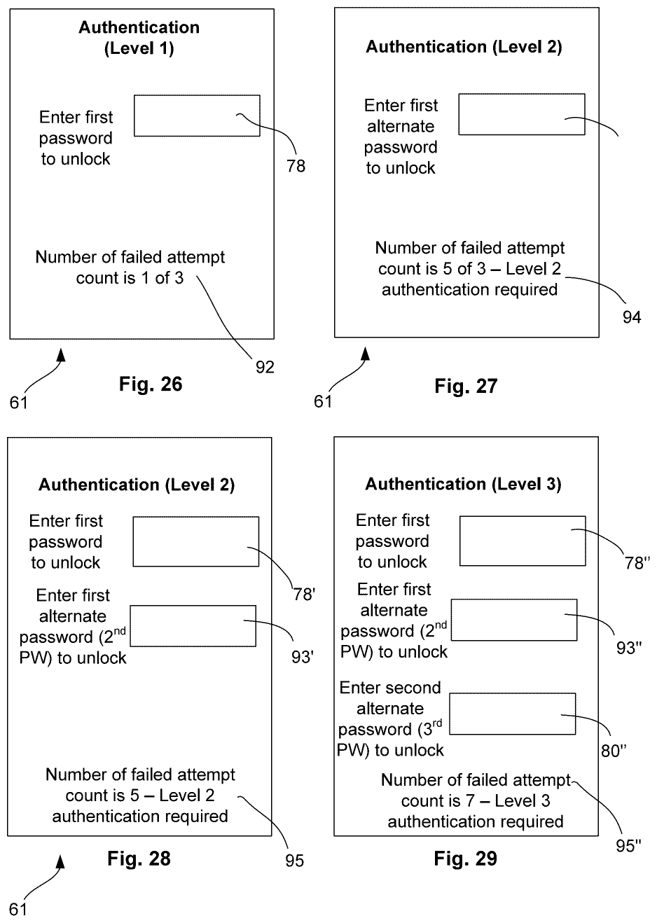

After mounting the data storage device, the method includes software generating a user interface 61 at the host device 4 as shown in FIG. 26 to prompt the user to enter the first password 11 in text box 78. In this example, the user interface 61 also notifies 92 the user of the number of failed attempt counter 31 is 1 of 3. In this example, this signifies that this is below the first specified threshold 33 which is 3. After the first password 11 is entered into the user interface, the host device 4 sends the first password 11 to be received 110 at the data storage device 3.

The method 100′ then includes comparing 120 the received first password 11 with the first authentication dataset 13. The method including checking 129 that the required number of authentication levels required to unlock matches the authentication level of the current session. In this instance, only a first level of authentication is required (because failed attempt counter (with a value of one) is less than the first specified threshold (with a value of 3)). Therefore, based on the first password 11 corresponding to the first authentication dataset 13, the method includes unlocking 130 the data storage device 3 to enable the host device 4 to access at least a secured portion 7 of a storage medium 5 of the data storage device 3.

### Incrementing the Failed Attempt Counter 31

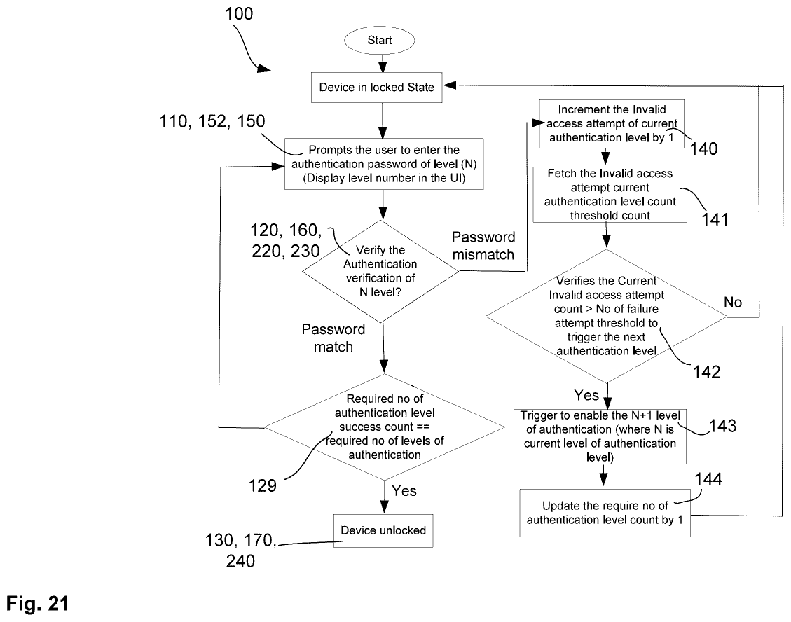

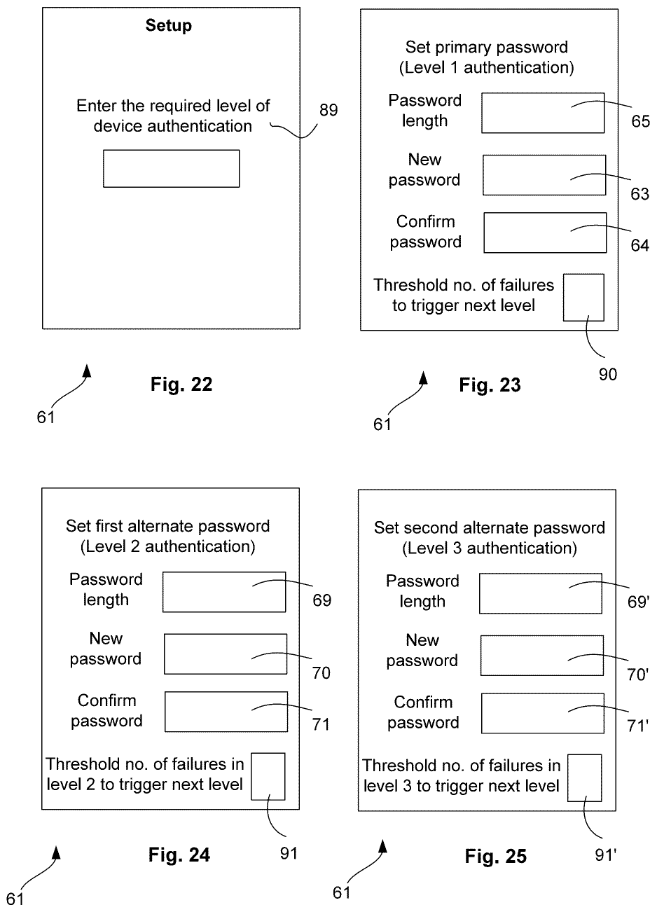

Referring to FIG. 21, if an incorrect password is entered, then the result of comparing 120 the first password 11 and the first authentication dataset 13 will result in a password mismatch. Therefore, in response to the first password 11 that does not correspond to the first authentication dataset 13, the method further comprises incrementing 140 a failed attempt counter 31.

The method further includes receiving 141 the first specified threshold 33 (or in further cases the second or subsequent specified threshold 35) from the memory 16. In this example, the threshold is three. The method 100′ includes checking 142 the failed attempt counter 31 compared with the specified thresholds 33, 35. In response to the failed attempt counter 31 satisfying, or exceeding, the first specified threshold 33, unlocking 130 the first data storage device 3 in the first mode 10 is disabled. That is, unlocking 130 using the first level of authentication, with just the first password 11, is prevented. This can be achieved by triggering 143 an increase of the current authentication level (such as to the second level of authentication) and subsequently updating the current authentication level in the memory 16. Thus during the next attempt at authentication, the method requires multiple valid passwords to satisfy the increased authentication level.

### Unlocking in Second Mode 20

An example of unlocking after a failed attempt counter 31 has exceeded the first specified threshold 33 will now be described with reference to FIGS. 26 and 27. In this example, the method includes receiving 152 a subsequent first password 11′ from the host device 4. This can be entered via the graphical user interface 61 similar to the one illustrated in FIG. 26 (but with a notification 92 that will state a failed attempt counter higher than the threshold and that Level 2 authentication 2 is required). Upon receiving the subsequent first password 11′, this is password is then compared 120 with the first authentication dataset 13 (as provided in the first mode 10).

The method then checks 129 the number of authentication levels required, and since a second level of authentication is required, the method proceeds to prompt the user to enter the second level authentication password (which in this case is the first alternate password 23). Thus the method then proceeds, at least in part, to operate in the second mode 20 by receiving 150, from the host device 4, at least one alternate password 21. This is illustrated in FIG. 27 where the user interface 61 includes a text box 93 to enter the first alternate password 23 as well as a notification 94 that the failed attempt counter 31 is currently 5 and therefore second level authentication is required. The first alternate password 23 is then sent to the data storage device 4 whereby it is compared 160 with the at least one alternate authentication dataset 23. The method once again includes checking 129 number of authentication levels meets the current level of authentication (which is the second level in this case and is thus satisfied). Based on the first alternate password 21 corresponding to the at least one alternate authentication dataset 23, the method further includes unlocking 170 the data storage device 3. Unlocking 170 can include enabling access to the secured portion 7. In other examples, unlocking can also include enabling reset of one or more passwords and their respective authentication datasets. When unlocked, the data storage device 3 in the second mode 20 also includes resetting the failed attempt counter 31 (such as resetting it back to zero).

### Unlocking in a Third Mode 30

A further example of unlocking the device in the third mode 30 will now be described with reference to FIGS. 28 and 29. In this example, the third mode 30 operates in response to the failed attempt counter 31 satisfying, or exceeding, the specified threshold 33.

Referring to FIG. 28, the graphical user interface 61 includes a notification 95 that notifies the user that the failed attempt counter 31 is above the specified threshold and that a second level of authentication is required. The graphical user interface 61 also prompts the user to provide both the first password 11 into and the first alternate password 21 into respective text boxes 78′, 93′.

The first password 11 and the first alternate password 21 is the received at the data storage device 3. The first password 11 is compared 220 with the first authentication dataset 13 and the first alternate password 21 is compared 230 with the alternate authentication dataset 23. Based on both the first password 11 and first alternate password 23 corresponding to the respective authentication datasets 13, 23, the method includes unlocking 240 the storage device 3. Like the above examples, the method can subsequently include resetting the failed attempt counter.

FIG. 29 illustrates an example of the graphical user interface 61 in a third mode 30 where unlocking includes a third level of authentication. In this examples, the method also includes a second specified threshold 35 that is higher than the first specified threshold 33. For illustrative purposes, the first specified threshold has a value of three and the second specified threshold has a value of six. The first specified threshold 33 is associated with the first alternate authentication dataset 23 (such as satisfying the first specified threshold 33 would trigger an authentication level that requires the first alternate password 21 to unlock). Similarly, the second specified threshold 35 is associated with the second alternate dataset 23′.

For illustrative purposes, the failed attempt counter 31 is at seven (as illustrated in notification 95″ in FIG. 29). In response to the failed attempt counter 31 (which in this example is at seven) satisfying, or exceeding, both the first specified threshold 33 (which is at three) and the second specified threshold 35 (which is at six), the third mode 30 further includes sending a request for both the first alternate password 21 and the second alternate password 21′. This is illustrated in FIG. 29 where the graphical user interface requests the alternate password in text boxes 93″, 80″. In addition, the first password 11 is also requested in text box 78″.

The method includes comparing 230 both the first alternate password 21, and the second alternate password 21′ with the respective first and second alternate authentication datasets 23, 23′. Unlocking 240 the data storage device 3 is based on both the first and second alternate passwords 21, 21′ corresponding to the first and second alternate authentication datasets 23, 23′.

### Example of Security Protocol Command in Enhanced Multi-Tier Password

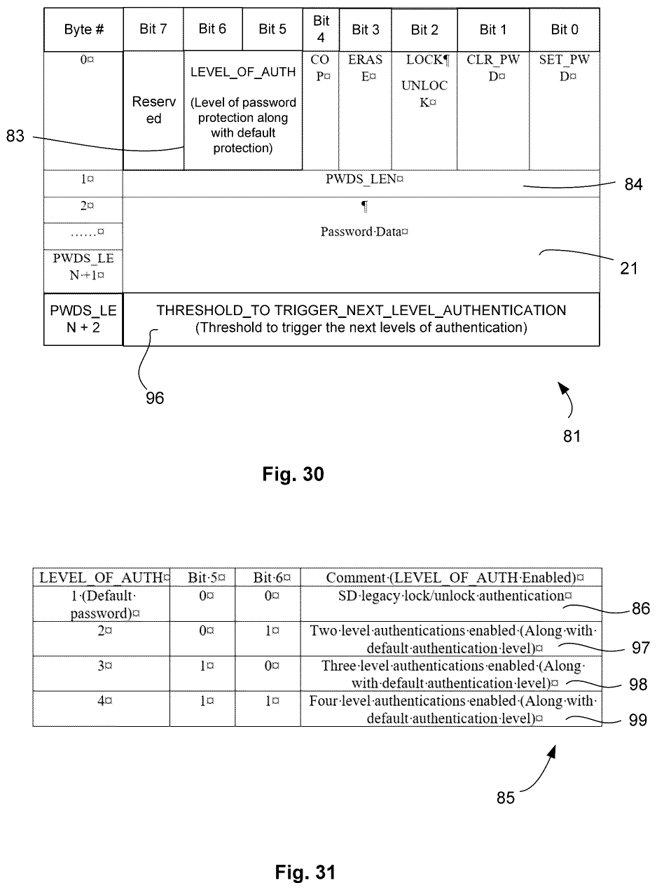

Like the earlier examples, the data storage device 3 and the host device 4 may communicate with security command protocols to unlock and/or lock the data storage device. 3. FIG. 30 illustrates a parameter list 81′ of a security protocol command based on CMD42.

The parameter list 81′ of CMD42 includes a reserve field 83 at bits 5, 6 (and in some examples bit 7) of byte 0. The reserve field 83, in this illustrated example, is used as an identifier for the alternate password 21. In some examples, this reserve field is used as an identifier of the level of authentication associated with the alternate password 21. A password length 84, of the alternate password 21 sent in the security protocol command, is provided at byte 1 of the parameter list 81. Finally, the password 21 is provided in byte 2 (and subsequent bytes) in the security protocol command.

In addition, and in contrast to the example in FIG. 17, further bytes (in this case the last byte denoted by reference 96) includes the specified threshold 33, 35 to trigger the next level of authentication.

FIG. 31 illustrates a truth table 85 for the reserve bit 5 and bit 6 in byte 0. If both bit 5 and bit 6 are set to zero, then the security protocol command is operating in a legacy mode 86. That is, using CMD42 in accordance with known use where no additional levels (other than the first level) of authentication are set.

If bit 5 is set to zero and bit 6 is set to one, this is indicative that there are two level 97 of password recovery being enabled. That is, a first alternate password 21 and corresponding first alternate authentication dataset 23, has been enabled. In a further example, where three levels 98 of recovery authentication is enabled, bit 5 is set to one and bit 6 is set to zero. The three levels of recovery authentication includes both a first alternate password and a second alternate password 21′. It is to be appreciated additional levels, could be used (such as four levels with bit 5 and bit 6 set to one). Furthermore, reserve bit 7 in byte 0 could be used which can enable specifying up to eight levels of authentication.

Like earlier examples, when the data storage device 3 receives the security protocol command, the processor 8 is configured to determine 104 from the parameter list 81′, the alternate passwords and the authentication level associated with that password. The data storage device 3 can also determine, the specified threshold relevant to the password.

### Advantages

In some examples, the system and method disclosed herein enables the alternate password to be used as a recovery password in case the first password has been forgotten (or otherwise unavailable). This can enable the data in the data storage device to be recovered and, in some examples, enable the first password to be reset.

In other examples, the system and method disclosed herein provides a system that includes multiple tiers of passwords that corresponds to levels of authentication. For example, if multiple unsuccessful attempts to unlock the drive is made (using invalid password), the authentication levels increase to require additional valid alternate password to be entered to unlock the data storage device. This method and system can make the data storage device more resistant to brute force attacks.

### Variations

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method to unlock a data storage device, comprising:
in a first mode:
receiving, from a host device, a first password;
comparing the first password with a first authentication dataset; and
based on the first password corresponding to the first authentication dataset, unlocking the data storage device to enable the host device to access at least a secured portion of a storage medium of the data storage device;
wherein responsive to a user selection to operate in a second mode, or responsive to the first password not corresponding to the first authentication dataset, the method includes operating in the second mode, the second mode comprising:
receiving, from the host device, at least one alternate password;
comparing the at least one alternate password with at least one alternate authentication dataset; and
based on the at least one alternate password corresponding to the at least one alternate authentication dataset, unlocking the data storage device to:
enable reset of the first authentication dataset; or
enable the host device to access the secured portion.

2. A method according to claim 1, wherein the at least one alternate authentication dataset includes a plurality of alternate authentication datasets corresponding to a plurality of alternate passwords, wherein each authentication dataset is associated with a corresponding alternate password, wherein the second mode further comprises:
receiving, from the host device, an alternate password indicator that is indicative of a specific alternate authentication dataset in the plurality of alternate authentication datasets; and
wherein comparing the at least one alternate password comprises comparing with the specific alternate authentication dataset.

3. A method according to claim 1, wherein in response to the first password not corresponding with the first authentication dataset, the method further comprises:
incrementing a failed attempt counter,
wherein, in response to the failed attempt counter satisfying, or exceeding, a first specified threshold, unlocking the data storage device in the first mode is disabled.

4. A method according to claim 3, wherein in response to:
the failed attempt counter satisfying, or exceeding, the first specified threshold; and
receiving, from the host device, a subsequent first password that corresponds with the first authentication dataset, the method further comprises operating in the second mode, and
in response to unlocking the data storage device in the second mode, the method further comprises resetting the failed attempt counter.

5. A method according to claim 3, wherein in response to the failed attempt counter satisfying, or exceeding, a first specified threshold, the method includes operating in a third mode comprising:
receiving, from the host device, a subsequent first password and at least one alternate password;
comparing the first password with the first authentication dataset;
comparing the at least one alternate password with at least one alternate authentication dataset; and
based on both the first password corresponding to the first authentication dataset and the at least one alternate password corresponding to the at least one alternate authentication dataset, unlocking the data storage device to enable the host device to access the secured portion of the storage medium.

6. A method according to claim 5, further comprising a second specified threshold higher than the first specified threshold,
wherein first specified threshold and second specified threshold are associated with respective first and second alternate authentication datasets,
wherein in response to the failed attempt counter satisfying, or exceeding, both the first specified threshold and the second specified threshold, the third mode further comprises:
sending a request for at least a first alternate password and a second alternate password;
wherein the step of receiving the first password and at least one alternate password comprises receiving the first alternate password and the second alternate password;
wherein comparing the at least one alternate password with at least one alternate authentication dataset comprises:
comparing the first alternate password with the first alternate authentication dataset; and
comparing the second alternate password with the second alternate authentication dataset;
wherein unlocking the data storage device is based on both the first and second alternate passwords corresponding to the first and second alternate authentication datasets.

7. A method according to claim 1, wherein in the second mode, receiving the at least one password comprises:
receiving, from the host device, a secure digital (SD) security protocol command,
determining, from a parameter list of the SD security protocol command, the at least one alternate password;
determining, from the bit 5, 6, and 7 of byte 0 of the parameter list, a identifier of the at least one alternate password; and
based on the identifier of the at least one password, identifying the at least one alternate authentication dataset for the step of comparing the at least one alternate passwords with the at least one authentication dataset.

8. A method according to claim 1, wherein a first password length of the first password is different to an alternate password length of one of the at least one alternate password.

9. A method according to claim 1, wherein the data storage device is a secure digital (SD) card.

10. A data storage device comprising:
a storage medium configured to store user data;
at least one processor, wherein in a first mode the at least one processor is configured, individually or in combination, to:
receive, from a host device, a first password;
compare the first password with a first authentication dataset; and
based on the first password corresponding to the first authentication dataset, unlock the data storage device to enable the host device to access at least a secured portion of a storage medium of the data storage device;
wherein responsive to a user selection to operate in a second mode, or responsive to a first password that does not correspond to the first authentication dataset, the at least one processor is configured, individually or in combination, to operate in a second mode to:
receive, from the host device, at least one alternate password;
compare the at least one alternate password with at least one alternate authentication dataset; and
based on the at least one alternate password corresponding to the at least one alternate authentication dataset, unlock the data storage device to:
enable reset of the first authentication dataset; or
enable the host device to access the secured portion.

11. A data storage device according to claim 10, wherein the at least one alternate authentication dataset includes a plurality of alternate authentication datasets corresponding to a plurality of alternate passwords, wherein each authentication dataset is associated with a corresponding alternate password,
wherein in the second mode, the at least one processor is further configured, individually or in combination, to:
receive, from the host device, an alternate password indicator that is indicative of a specific alternate authentication dataset in the plurality of alternate authentication datasets; and
wherein to compare the at least one alternate password comprises comparing with the specific alternate authentication dataset.

12. A data storage device according to claim 10, wherein in response to the first password that does not correspond with the first authentication data set, the at least one processor is further configured, individually or in combination, to:
increment a failed attempt counter,
wherein, in response to the failed attempt counter satisfying, or exceeding, a first specified threshold, unlocking the data storage device in the first mode is disabled.

13. A data storage device according to claim 12, wherein in response to:
the failed attempt counter satisfying, or exceeding, the first specified threshold; and
receiving, from the host device, a subsequent first password that corresponds with the first authentication dataset,
the at least one processor is further configured, individually or in combination, to operate in the second mode, and
in response to the data storage device being unlocked in the second mode, the at least one processor is further configured, individually or in combination, to reset the failed attempt counter.

14. A data storage device according to claim 12, wherein in response to the failed attempt counter satisfying, or exceeding, a first specified threshold, the at least one processor is further configured, individually or in combination, to operate in a third mode to:
receive, from the host device, a subsequent first password and at least one alternate password;
compare the first password with the first authentication dataset;
compare the at least one alternate password with at least one alternate authentication dataset; and
based on both the first password corresponding to the first authentication dataset and the at least one alternate password corresponding to the at least one alternate authentication dataset, unlock the data storage device to enable the host device to access the secured portion of the storage medium.

15. A data storage device according to claim 14, further comprising a second specified threshold higher than the first specified threshold,
wherein first specified threshold and second specified threshold are associated with respective first and second alternate authentication datasets,
wherein in response to the failed attempt counter satisfying, or exceeding, both the first specified threshold and the second specified threshold, the at least one processor in the third mode is further configured, individually or in combination, to:
send a request for at least a first alternate password and a second alternate password;
wherein to receive the first password and at least one alternate password comprises to receive the first alternate password and the second alternate password;
wherein to compare the at least one alternate password with at least one alternate authentication dataset comprises:
to compare the first alternate password with the first alternate authentication dataset; and
to compare the second alternate password with the second alternate authentication dataset;
wherein to unlock the data storage device is based on both the first and second alternate passwords corresponding to the first and second alternate authentication datasets.

16. A data storage device according to claim 10, wherein in the second mode, to receive the at least one password comprises the at least one processor configured, individually or in combination, to:
receive, from the host device, a secure digital (SD) security protocol command;
determine, from a parameter list of the SD security protocol command, the at least one alternate password;
determine, from the bit 5, 6, and 7 of byte 0 of the parameter list, a identifier of the at least one alternate password; and
based on the identifier of the at least one password, identify the at least one alternate authentication dataset to compare the at least one alternate passwords with the at least one authentication dataset.

17. A data storage device according to claim 10, wherein a first password length of the first password is different to an alternate password length of one of the at least one alternate password.

18. A data storage device according to claim 10, wherein the data storage device is a secure digital (SD) card.

19. A data storage device comprising:
means for storing user data;
means to operate in a first mode comprising:
means for receiving, from a host device, a first password;
means for receiving the first password with a first authentication dataset; and
based on the first password corresponding to the first authentication dataset, means for unlocking the data storage device to enable the host device to access at least a secured portion of the means for storing user data;
means to operate in a second mode that is responsive to a user selection to operate in a second mode, or responsive to a first password that does not correspond to the first authentication dataset, wherein the means to operate in the second mode comprising:
means for receiving, from the host device, at least one alternate password;
means for comparing the at least one alternate password with at least one alternate authentication dataset; and
based on the at least one alternate password corresponding to the at least one alternate authentication dataset, means for unlocking the data storage device to:
enable reset of the first authentication dataset; or
enable the host device to access the secured portion.

20. A data storage device according to claim 19, wherein the at least one alternate authentication dataset includes a plurality of authentication datasets corresponding to a plurality of passwords, wherein each authentication dataset is associated with a corresponding alternate password, and the means to operate in the second mode further comprising:
means to receive, from the host device, an alternate password indicator that is indicative of a specific alternate authentication dataset in the plurality of alternate authentication datasets; and
wherein the means for comparing the at least one alternate passwords comprises means for comparing the at least one alternate password with the specific authentication dataset.
